(19) United States
(12) Patent Application Publication
(10) Pub. No.: US 2026/0067965 A1
(43) Pub. Date: Mar. 5, 2026

(54) ELECTRONIC APPARATUS FOR ESTABLISHING A COMMUNICATION CHANNEL WITH ANOTHER ELECTRONIC APPARATUS WITHOUT A TIMEOUT AND CONTROL METHOD THEREOF

(71) Applicant: Samsung Electronics Co., Ltd., Suwon-si (KR)

(72) Inventors: Youngjo SEO, Suwon-si (KR); Suyeon You, Suwon-si (KR); Jangwon Lee, Suwon-si (KR)

(73) Assignee: Samsung Electronics Co., Ltd., Suwon-si (KR)

(21) Appl. No.: 19/256,891

(22) Filed: Jul. 1, 2025

Related U.S. Application Data
(63) Continuation of application No. PCT/KR2025/007496, filed on May 30, 2025.

(30) Foreign Application Priority Data
Sep. 5, 2024 (KR) 10-2024-0121140

(51) Int. Cl. H04W 76/15; G06F 3/16

(52) U.S. Cl. CPC H04W 76/15; G06F 3/162

(57) ABSTRACT

A first electronic apparatus includes memory storing instructions, a first communication interface, a second communication interface, and at least one processor, where the instructions, when executed by the at least one processor individually or collectively, cause the first electronic apparatus to, based on the first electronic apparatus being connected to a network through the first communication interface, control the first communication interface to request, from a server, setting information on a first data transmission method of a second electronic apparatus, receive the setting information from the server through the first communication interface, and control the second communication interface to perform communication with the second electronic apparatus based on the setting information.

### CROSS-REFERENCE TO RELATED APPLICATIONS

This application is a continuation of PCT/KR2025/007496, filed on May 30, 2025, in the Korean Intellectual Property Receiving Office, which is based on and claims priority to Korean Patent Application No. 10-2024-0121140, filed on Sep. 5, 2024, in the Korean Intellectual Property Office, the disclosures of which are incorporated by reference herein in their entireties.

### BACKGROUND

### 1. Field

The disclosure relates to an electronic apparatus and a control method thereof, and more particularly, to an electronic apparatus that establishes a communication channel with another electronic apparatus, and a control method thereof.

### 2. Description of Related Art

Fueled by the development of electronic technologies, various types of electronic apparatuses are being developed. In particular, recently, a communication channel may be formed by various communication methods, and thus time for setting a communication method is needed.

FIG. 1A and FIG. 1B are diagrams illustrating a connection method according to related art.

For example, recently, an audio transmission path is set based on a sink device by applying an operation regarding a high-definition multimedia interface (HDMI) specification. For example, as illustrated in FIG. 1A, in the case of a first electronic apparatus such as a sound bar, if a cable is connected with a second electronic apparatus such as a television (TV), the first electronic apparatus may attempt an enhanced audio return channel (eARC) connection by transmitting a COMMA signal to the second electronic apparatus. The first electronic apparatus may operate in an audio return channel (ARC) mode or operate in an eARC mode based on whether a heartbeat signal is received from the second electronic apparatus. Here, as the first electronic apparatus is unaware of setting information of the second electronic apparatus, the first electronic apparatus may attempt connection by an eARC, and then set a path to an eARC or an ARC after the operation state of the second electronic apparatus is identified. That is, the first electronic apparatus requires a standby time for identifying the operation state of the second electronic apparatus. For example, the standby time may be 500 ms, as illustrated in FIG. 1B.

Such a connection method has a problem that it makes difficult to distinguish setting of a path due to abnormality of a signal and normal setting of a path according to setting information of a sink device, and a latency according to waiting until a timeout defined in the specification is generated.

Also, a sink device and a source device may identify a specification wherein audio decoding is possible (audio capability) of a connected audio output device (a repeater), information on the audio output delay time (lip-sync), and characteristics of the audio output device through a consumer electronics control (CEC), an eARC, and an extended display identification data (EDID). However, there is a problem that the sink device and the source device cannot simultaneously identify information that fits the characteristics of the audio output device such as the output delay time according to their respective audio codecs.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, a first electronic apparatus may include memory storing instructions, a first communication interface, a second communication interface, and at least one processor, where the instructions, when executed by the at least one processor individually or collectively, cause the first electronic apparatus to, based on the first electronic apparatus being connected to a network through the first communication interface, control the first communication interface to request, from a server, setting information on a first data transmission method of a second electronic apparatus, receive the setting information from the server through the first communication interface, and control the second communication interface to perform communication with the second electronic apparatus based on the setting information.

The instructions, when executed by the at least one processor individually or collectively, may further cause the first electronic apparatus to, while the first electronic apparatus is connected to the second electronic apparatus through the second communication interface, based on the first electronic apparatus being connected to the network through the first communication interface, control the first communication interface to request, from the server, the setting information, receive the setting information from the server through the first communication interface, and based on receiving the setting information, control the second communication interface to perform communication with the second electronic apparatus based on a second data transmission method corresponding to the setting information.

The instructions, when executed by the at least one processor individually or collectively, may further cause the first electronic apparatus to change a content based on the second data transmission method corresponding to the setting information, and control the second communication interface to transmit the changed content to the second electronic apparatus.

The instructions, when executed by the at least one processor individually or collectively, may further cause the first electronic apparatus to, while the first electronic apparatus is connected to the network through the first communication interface, based on the first electronic apparatus being connected to the second electronic apparatus through the second communication interface, control the first communication interface to re-request, from the server, the setting information, re-receive the setting information from the server through the first communication interface, and based on re-receiving the setting information, control the second communication interface to perform communication with the second electronic apparatus based on a third data transmission method corresponding to the re-received setting information.

The instructions, when executed by the at least one processor individually or collectively, may further cause the first electronic apparatus to, based on receiving the setting information, store the setting information in the memory, and based on the setting information being updated in the second electronic apparatus, and the updated setting information being received from the server through the first communication interface, control the second communication interface to perform communication with the second electronic apparatus based on the updated setting information.

The first data transmission method may include at least one of an audio return channel (ARC) communication method or an enhanced audio return channel (eARC) communication method.

The setting information may include at least one of compatibility information of the second electronic apparatus for the eARC communication method or setting information of the second electronic apparatus for the eARC communication method.

The instructions, when executed by the at least one processor individually or collectively, may further cause the first electronic apparatus to, based on the setting information not being received, control the second communication interface to perform communication with the second electronic apparatus on based on the eARC communication method, and based on communication with the second electronic apparatus not being performed during a predetermined time, control the second communication interface to perform communication with the second electronic apparatus based on the ARC communication method.

The second communication interface may include an interface for performing communication by a high-definition multimedia interface (HDMI) communication method.

The instructions, when executed by the at least one processor individually or collectively, may further cause the first electronic apparatus to control the first communication interface to request, from the server, specification information of the first electronic apparatus, receive the specification information from the server through the first communication interface, and control the second communication interface to transmit the specification information to the second electronic apparatus.

The specification information may include at least one of an audio format supported by the first electronic apparatus, an audio sample rate, or delay information.

According to an aspect of the disclosure, a control method of a first electronic apparatus may include, based on the first electronic apparatus being connected to a network through a first communication interface of the first electronic apparatus, controlling the first communication interface to request, from a server, setting information on a first data transmission method of second electronic apparatus, receiving the setting information from the server through the first communication interface, and controlling a second communication interface of the first electronic apparatus to perform communication with the second electronic apparatus based on the setting information.

The controlling the first communication interface may include, while the first electronic apparatus is connected to the second electronic apparatus through the second communication interface, based on the first electronic apparatus being connected to the network through the first communication interface, controlling the first communication interface to request the setting information from the server, and wherein the controlling the second communication interface may include, based on receiving the setting information, controlling the second communication interface to perform communication with the second electronic apparatus based on a second data transmission method corresponding to the setting information.

The controlling the second communication interface may include changing a content based on the second data transmission method corresponding to the setting information and controlling the second communication interface to transmit the changed content to the second electronic apparatus.

The method may include, while the first electronic apparatus is connected to the network through the first communication interface, based on the first electronic apparatus being connected to the second electronic apparatus through the second communication interface, controlling the first communication interface to re-request the setting information to the server, re-receiving the setting information from the server through the first communication interface, and based on re-receiving the setting information, controlling the second communication interface to perform communication with the second electronic apparatus based on a third data transmission method corresponding to the re-received setting information.

The method may include, based on receiving the setting information, storing the setting information, and based on the setting information being updated in the second electronic apparatus, and the updated setting information being received from the server through the first communication interface, controlling the second communication interface to perform communication with the second electronic apparatus based on the updated setting information.

The first data transmission method may include at least one of an ARC communication method or an eARC communication method.

The setting information may include at least one of compatibility information of the second electronic apparatus for the eARC communication method or setting information of the second electronic apparatus for the eARC communication method.

The method may include, based on the setting information not being received, control the second communication interface to perform communication with the second electronic apparatus based on the eARC communication method, and based on communication with the second electronic apparatus not being performed during a predetermined time, control the second communication interface to perform communication with the second electronic apparatus based on the ARC communication method.

According to an aspect of the disclosure, a non-transitory, computer-readable, storage medium may store instructions that, when executed by at least one processor, cause a first electronic apparatus to, based on the first electronic apparatus being connected to a network through a first communication interface of the first electronic apparatus, control the first communication interface to request, from a server, setting information on a first data transmission method of second electronic apparatus, receive the setting information from the server through the first communication interface, and control a second communication interface of the first electronic apparatus to perform communication with the second electronic apparatus based on the setting information.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1A and FIG. 1B are diagrams illustrating a connection method according to related art;

FIG. 2 is a diagram illustrating a configuration of an electronic system according to one or more embodiments;

FIG. 3 is a diagram illustrating a configuration of an electronic apparatus according to one or more embodiments;

FIG. 4 is a diagram illustrating a detailed configuration of an electronic apparatus according to one or more embodiments;

FIG. 5 is a diagram illustrating an electronic apparatus and another electronic apparatus according to one or more embodiments;

FIG. 6 is a flowchart illustrating a method of forming a communication channel by receiving setting information in advance according to one or more embodiments;

FIG. 7 is a diagram illustrating setting information according to one or more embodiments;

FIG. 8 is a flowchart illustrating a method of transmitting specification information according to one or more embodiments;

FIG. 9 to FIG. 12 are diagrams illustrating specification information according to one or more embodiments;

FIG. 13 is a diagram illustrating control of a communication method according to one or more embodiments; and

FIG. 14 is a flowchart illustrating a control method of an electronic apparatus according to one or more embodiments.

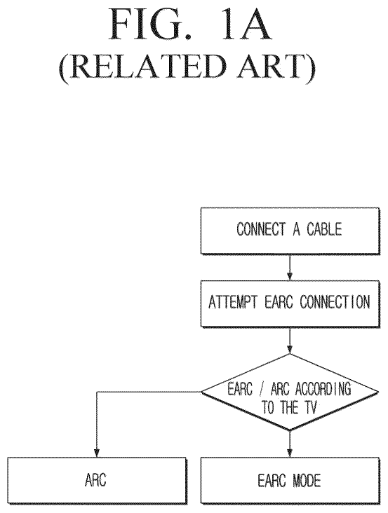

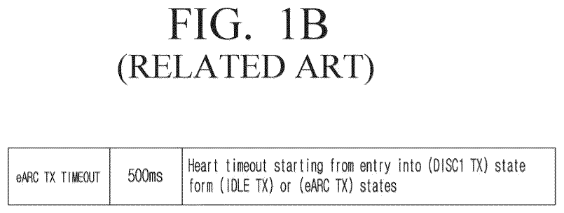

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

The purpose of the disclosure is in providing an electronic apparatus that receives setting information on a data transmission method of another electronic apparatus from a server, and establishes a communication channel with the another electronic apparatus without a timeout, and a control method thereof.

Hereinafter, the disclosure will be described in detail with reference to the accompanying drawings.

As terms used in the embodiments of the disclosure, general terms that are currently used widely were selected, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g., elements such as numbers, functions, operations, and components), and do not exclude the existence of additional characteristics.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c

Further, the expressions “first,” “second,” and the like used in this specification may describe various elements regardless of any order and/or degree of importance. Also, such expressions are used only to distinguish one element from another element, and are not intended to limit the elements.

Also, singular expressions include plural expressions, unless defined obviously differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in this specification, the term “user” may refer to a person who uses an electronic apparatus or an apparatus using an electronic apparatus (e.g., an artificial intelligence electronic apparatus).

Hereinafter, various embodiments of the disclosure will be described in detail with reference to the accompanying drawings.

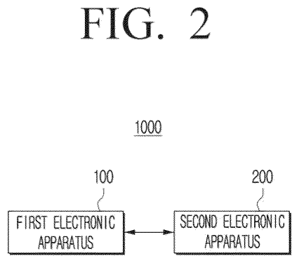

FIG. 2 is a diagram illustrating a configuration of an electronic system 1000 according to one or more embodiments. As illustrated in FIG. 2, the electronic system 1000 includes a first electronic apparatus 100 and a second electronic apparatus 200. The first electronic apparatus 100 may be referred to as an electronic apparatus 100, and the second electronic apparatus 200 may be referred to as “another” electronic apparatus 200 or “the other” electronic apparatus 200.

The first electronic apparatus 100 is an apparatus that outputs sounds, and may be implemented as a sound bar, etc. However, the disclosure is not limited thereto, and any apparatus that includes a speaker, and that is capable of outputting an audio sound may be the first electronic apparatus 100.

The first electronic apparatus 100 may form or establish a communication channel with the second electronic apparatus 200, and receive a sound from the second electronic apparatus 200. For example, the first electronic apparatus 100 may be connected with the second electronic apparatus 200 by a high-definition multimedia interface (HDMI) communication method, and receive a sound by one of an audio return channel (ARC) communication method or an enhanced audio return channel (eARC) communication method.

The first electronic apparatus 100 may receive setting information for a data transmission method of the second electronic apparatus 200 from a server, and transmit and receive data with the second electronic apparatus 200 by one of the ARC communication method or the eARC communication method based on the setting information.

The second electronic apparatus 200 is an apparatus that provides multimedia information to the first electronic apparatus 100, and may be implemented as a television (TV), a projector, a desktop personal computer (PC), a laptop, a tablet PC, etc. However, the disclosure is not limited thereto, and any apparatus that may provide multimedia information to the first electronic apparatus 100 may be the second electronic apparatus 200.

The second electronic apparatus 200 may form a communication channel with the first electronic apparatus 100, and transmit a sound. For example, the second electronic apparatus 200 may be connected with the first electronic apparatus 100 by an HDMI communication method, and transmit a sound by one of an ARC communication method or an eARC communication method.

The second electronic apparatus 200 may transmit the setting information for the data transmission method of the second electronic apparatus 200 to the server. For example, in case the second electronic apparatus 200 is turned on, or is connected to a network, or the setting information is changed, the second electronic apparatus 200 may transmit the setting information for the data transmission method of the second electronic apparatus 200 to the server.

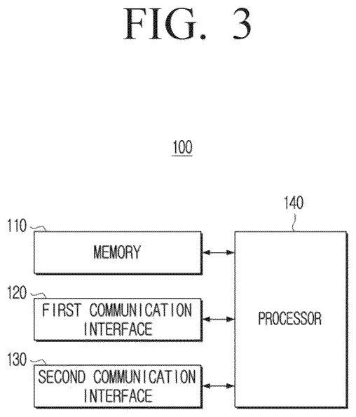

FIG. 3 is a diagram illustrating a configuration of the first electronic apparatus 100 according to one or more embodiments.

According to FIG. 3, the first electronic apparatus 100 includes memory 110, a first communication interface 120, a second communication interface 130, and a processor 140. However, the disclosure is not limited thereto, and the first electronic apparatus 100 may be implemented in a form where some components are omitted.

The memory 110 may refer to hardware that stores information such as data, etc. in an electric or a magnetic form, such that the processor 140, etc. may access the information. For this, the memory 110 may be implemented as at least one hardware among non-volatile memory, volatile memory, flash memory, a hard disk drive (HDD) or a solid state drive (SSD), random access memory (RAM), read-only memory (ROM), etc.

In the memory 110, at least one instruction for the operation of the first electronic apparatus 100 and/or the processor 140 may be stored. Here, an instruction is a code unit instructing the operation of the first electronic apparatus 100 or the processor 140, and the instruction may be in a machine language which is a language that may be understood by a computer. Alternatively, in the memory 110, a plurality of instructions that perform a specific function of the first electronic apparatus 100 or the processor 140 may be stored as an instruction set.

Also, in the memory 110, data which is information in bit or byte units that may indicate characters, numbers, images, etc. may be stored. For example, in the memory 110, at least one instruction for controlling the first electronic apparatus 100, the setting information for the data transmission method of the second electronic apparatus 200, etc. may be stored.

The memory 110 may be accessed by the processor 140, and reading/recording/correction/deletion/update, etc. for an instruction, an instruction set, or data may be performed by the processor 140.

The first communication interface 120 is a component that performs communication with various types of external apparatuses according to various types of communication methods. For example, the first electronic apparatus 100 may perform communication with the server through the first communication interface 120.

The first communication interface 120 may include a Wi-Fi module, a Bluetooth module, an infrared communication module, and a wireless communication module, etc. Here, each communication module may be implemented in the form of at least one hardware chip.

A Wi-Fi module and a Bluetooth module perform communication by a Wi-Fi method and a Bluetooth method, respectively. In the case of using a Wi-Fi module or a Bluetooth module, various types of connection information such as an SSID and a session key, etc. is transmitted and received first, and connection of communication is performed by using the information, and various types of information may be transmitted and received thereafter. An infrared communication module performs communication according to an infrared Data Association (IrDA) technology of transmitting data to a near field wirelessly by using infrared rays between visible rays and millimeter waves.

A wireless communication module may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

Alternatively, the first communication interface 120 may include at least one of a local area network (LAN) module, an Ethernet module, or a wired communication module that performs communication by using a pair cable, a coaxial cable, or an optical fiber cable, etc.

The second communication interface 130 may be a component that performs communication with the second electronic apparatus 200. For example, the second communication interface 130 may be an interface for performing communication by an HDMI communication method. However, the disclosure is not limited thereto, and the second communication interface 130 may further include an interface such as a display port (DP), a Thunderbolt, a universal serial bus (USB), an RGB, a D-SUB, a digital visual interface (DVI), etc.

The processor 140 controls the overall operations of the first electronic apparatus 100. Specifically, the processor 140 may be connected with each component of the first electronic apparatus 100, and control the overall operations of the first electronic apparatus 100. For example, the processor 140 may be connected with components such as the memory 110, the first communication interface 120, etc., and control the operations of the first electronic apparatus 100.

The at least one processor 140 may include one or more of a central processing unit (CPU), a graphics processing unit (GPU), an accelerated processing unit (APU), a many integrated core (MIC), a neural processing unit (NPU), a hardware accelerator, or a machine learning accelerator. The at least one processor 140 may control one or a random combination of the other components of the first electronic apparatus 100, and perform an operation related to communication or data processing. Also, the at least one processor 140 may execute one or more programs or instructions stored in the memory 110. For example, the at least one processor 140 may perform the method according to an embodiment of the disclosure by executing the one or more instructions stored in the memory 110.

In case the method according to one or more embodiments includes a plurality of operations, the plurality of operations may be performed by one processor, or performed by a plurality of processors. For example, when a first operation, a second operation, and a third operation are performed by the method according to one or more embodiments, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor). Multiple variations and combinations of processors and operations may be implemented in accordance with an instruction or a set of instructions as will be understood by one of skill in the art from the disclosure herein.

The at least one processor 140 may be implemented as a single core processor including one core, or may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to one or more embodiments and perform the instruction, or the plurality of entire cores (or some of the cores) may be linked with one another, and read a program instruction for implementing the method according to one or more embodiments and perform the instruction.

In case the method according to one or more embodiments includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In one or more embodiments, the at least one processor 140 may include a system on chip (SoC) where at least one processor and other electronic components are integrated, a single core processor, a multicore processor, or a core included in the single core processor or the multicore processor. Also, the core may be implemented as a CPU, a GPU, an APU, a MIC, an NPU, a hardware accelerator, or a machine learning accelerator, etc., but embodiments of the disclosure are not limited thereto. However, hereinafter, operations of the first electronic apparatus 100 will be explained with the expression the processor 140, for the convenience of explanation.

When the first electronic apparatus 100 is connected to the network through the first communication interface 120, the processor 140 may control the first communication interface 120 to request setting information on a data transmission method of the second electronic apparatus 200 to the server. For example, when the first electronic apparatus 100 is turned on and connected to the network, the processor 140 may control the first communication interface 120 to request setting information on the data transmission method of the second electronic apparatus 200 from the server. As described herein, the processor 140 may request setting information and/or other information from the server, and this may be performed by generating and sending a request to retrieve the corresponding information from the server.

However, the disclosure is not limited thereto, and the processor 140 may control the first communication interface 120 to request setting information on the data transmission method of the second electronic apparatus 200 from the server by a predetermined time interval or on a predetermined time point. Alternatively, the processor 140 may control the first communication interface 120 to request setting information on the data transmission method of the second electronic apparatus 200 from the server when the processor 140 is connected with the second electronic apparatus 200.

The processor 140 may receive the setting information from the server through the first communication interface 120, and control the second communication interface 130 to perform communication with the second electronic apparatus 200 based on the setting information. For example, the processor 140 may change a content based on the data transmission method corresponding to the setting information, and control the second communication interface 130 to transmit the changed content to the second electronic apparatus 200.

If the setting information is not received, the processor 140 may control the second communication interface 130 to perform communication with the second electronic apparatus 200 based on the first communication method, and if communication with the second electronic apparatus 200 is not performed during a predetermined time, the processor 140 may control the second communication interface 130 to perform communication with the second electronic apparatus 200 based on the second communication method.

That is, if the setting information is not received, the processor 140 may attempt communication with the second electronic apparatus 200 by the first communication method, and identify whether communication with the second electronic apparatus 200 is possible by the first communication method during the predetermined time. If the predetermined time passes, the processor 140 may identify that communication with the second electronic apparatus 200 is not possible by the first communication method, and attempt communication with the second electronic apparatus 200 by the second communication method. Accordingly, in case the second electronic apparatus 200 does not support the first communication method or is set to not use the first communication method, a latency of the predetermined time or longer at the minimum may be needed until the first electronic apparatus 100 and the second electronic apparatus 200 communicate.

However, in case the processor 140 received the setting information, the processor 140 may attempt communication with the second electronic apparatus 200 by the first communication method or the second communication method based on the setting information, and thus a latency of the predetermined time or longer is not generated, and accordingly, the time until formation of a communication channel may be shortened.

While the first electronic apparatus 100 is connected to the second electronic apparatus 200 through the second communication interface 130, if the first electronic apparatus 100 is connected to the network through the first communication interface 120, the processor 140 may control the first communication interface 120 to request the setting information from the server, and receive the setting information from the server through the first communication interface 120, and when the setting information is received, the processor 140 may control the second communication interface 130 to perform communication with the second electronic apparatus 200 based on a data transmission method corresponding to the setting information.

Alternatively, while the first electronic apparatus 100 is connected to the network through the first communication interface 120, if the first electronic apparatus 100 is connected to the second electronic apparatus 200 through the second communication interface 130, the processor 140 may control the first communication interface 120 to re-request the setting information from the server, and re-receive the setting information from the server through the first communication interface 120, and when the setting information is re-received, the processor 140 may control the second communication interface 130 to perform communication with the second electronic apparatus 200 based on a data transmission method corresponding to the re-received setting information.

When the setting information is received, the processor 140 may store the setting information in the memory 110 (or another memory that does not include the executable instructions), and when the setting information is updated in the second electronic apparatus 200, and the updated setting information is received from the server through the first communication interface 120, the processor 140 may control the second communication interface 130 to perform communication with the second electronic apparatus 200 based on the updated setting information.

The data transmission method may include at least one of an ARC communication method or an eARC communication method.

However, the disclosure is not limited thereto, and the data transmission method may include methods of any various protocols.

The setting information may include at least one of compatibility information of the second electronic apparatus 200 for the eARC communication method or setting information of the second electronic apparatus 200 for the eARC communication method.

For example, the setting information may include compatibility information of the second electronic apparatus 200 for the eARC communication method, and if it is identified that the second electronic apparatus 200 does not support the eARC communication method based on the setting information, the processor 140 may control the second communication interface 130 to perform communication with the second electronic apparatus 200 based on the ARC communication method. Alternatively, the setting information may include the setting information of the second electronic apparatus 200 for the eARC communication method, and if it is identified that the second electronic apparatus 200 supports the eARC communication method, but is set to use the ARC communication method, the processor 140 may control the second communication interface 130 to perform communication with the second electronic apparatus 200 based on the ARC communication method.

If the setting information is not received, the processor 140 may control the second communication interface 130 to perform communication with the second electronic apparatus 200 based on the eARC communication method, and if communication with the second electronic apparatus 200 is not performed during the predetermined time, the processor 140 may control the second communication interface 130 to perform communication with the second electronic apparatus 200 based on the ARC communication method.

Accordingly, if the setting information is received, generation of a latency of waiting during the predetermined time may be prevented.

The processor 140 may control the first communication interface 120 to request specification information of the first electronic apparatus 100 from the server, and receive the specification information from the server through the first communication interface 120, and control the second communication interface 130 to transmit the specification information to the second electronic apparatus 200. Here, the specification information may include at least one of an audio format supported by the first electronic apparatus 100, an audio sample rate, or delay information.

However, the disclosure is not limited thereto, and the processor 140 may not request the specification information from the server, but control the second communication interface 130 to transmit the specification information stored in the memory 110 to the second electronic apparatus 200. Alternatively, the processor 140 may not perform any operation related to the specification information, but the second electronic apparatus 200 may receive the specification information of the first electronic apparatus 100 from the server.

The second electronic apparatus 200 may change an output time point of a video based on the specification information of the first electronic apparatus 100. For example, the second electronic apparatus 200 may identify how much an output time point of a sound provided by the second electronic apparatus 200 to the first electronic apparatus 100 is delayed based on the specification information of the first electronic apparatus 100, and delay an output time point of a video through the display of the second electronic apparatus 200 based on this. Through such an operation, sync of a video output from the second electronic apparatus 200 and a sound output from the first electronic apparatus 100 may be matched.

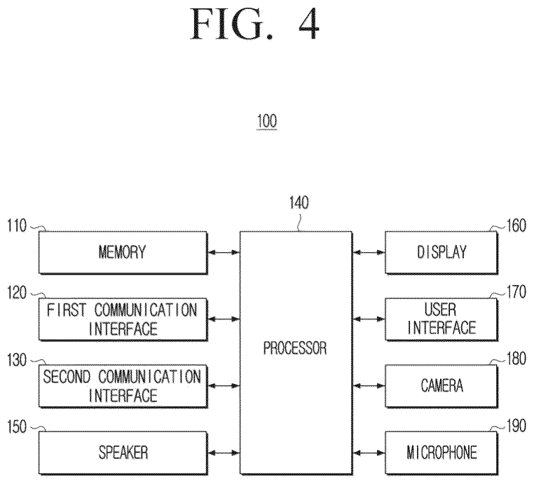

FIG. 4 is a diagram illustrating a detailed configuration of the first electronic apparatus 100 according to one or more embodiments. The first electronic apparatus 100 may include memory 110, a first communication interface 120, a second communication interface 130, and a processor 140. Also, according to FIG. 4, the first electronic apparatus 100 may further include a speaker 150, a display 160, a user interface 170, a camera 180, and a microphone 190. Description of aspects that are the same as or similar to those described above may be omitted.

The speaker 150 is a component that outputs not only various types of audio data processed at the processor 140, but also various types of notification sounds or voice messages, etc. For example, the processor 140 may output signals of some channels included in a sound through the speaker 150.

The speaker 150 may be implemented as a plurality of speakers. For example, the speaker 150 may include a front left speaker, a front right speaker, and a center speaker. However, the disclosure is not limited thereto, and implementation methods of the speaker 150 may be any diverse methods.

The display 160 is a component that displays images, and may be implemented as various forms of displays such as a liquid crystal display (LCD), an organic light emitting diodes (OLED) display, a plasma display panel (PDP), etc. Inside the display 160, a driving circuit that may be implemented in forms such as an a-si thin film transistor (TFT), a low temperature poly silicon (LTPS) TFT, an organic TFT (OTFT), etc., and a backlight unit, etc. may also be included together. The display 160 may be implemented as a touch screen combined with a touch sensor, a flexible display, a three-dimensional (3D) display, etc.

The user interface 170 may be implemented as a button, a touch pad, a mouse, and a keyboard, or may be implemented as a touch screen that may perform a display function and a manipulation input function together. A button may be various types of buttons such as a mechanical button, a touch pad, a wheel, etc. formed in any areas such as the front surface part or the side surface part, the rear surface part, etc. of the exterior of the main body of the first electronic apparatus 100.

The camera 180 is a component for photographing a still image or a moving image. The camera 180 may photograph a still image on a specific time point, but it may also photograph still images consecutively.

The camera 180 may photograph the front side of the first electronic apparatus 100, and photograph the actual environment of the front side of the first electronic apparatus 100. The processor 140 may identify a user from an image photographed through the camera 180.

The camera 180 includes a lens, a shutter, a diaphragm, a solid imaging element, an analog front end (AFE), and a timing generator (TG). The shutter adjusts the time when a light reflected on a subject enters the camera 180, and the diaphragm adjusts the amount of the light introduced into the lens by mechanically increasing or decreasing the size of the opening through which the light enters. When the light reflected on the subject is accumulated as photo charges, the solid imaging element outputs the phase due to the photo charges as an electric signal. The TG outputs a timing signal for reading out the pixel data of the solid imaging element, and the AFE samples and digitalizes the electric signal output from the solid imaging element.

The microphone 190 is a component for receiving input of a sound and converting it into an audio signal. The microphone 190 may be electrically connected with the processor 140, and receive a sound by control by the processor 140.

For example, the microphone 190 may be formed as an integrated type integrated to the upper side or the front surface direction, the side surface direction, etc. of the first electronic apparatus 100. Alternatively, the microphone 190 may be provided on a remote control, etc. separate from the first electronic apparatus 100. In this case, the remote control may receive a sound through the microphone 190, and provide the received sound to the first electronic apparatus 100.

The microphone 190 may include various components such as a microphone that collects a sound in an analogue form, an amp circuit that amplifies the collected sound, an analog/digital (A/D) conversion circuit that samples the amplified sound and converts it into a digital signal, a filter circuit that removes noise components from the converted digital signal, etc.

The microphone 190 may also be implemented in a form of a sound sensor, and it may be of any type if it is a component that may collect sounds.

As described above, the first electronic apparatus 100 may receive the setting information on the data transmission method of the second electronic apparatus 200 from the server, and form a communication channel with the second electronic apparatus 200 without a timeout.

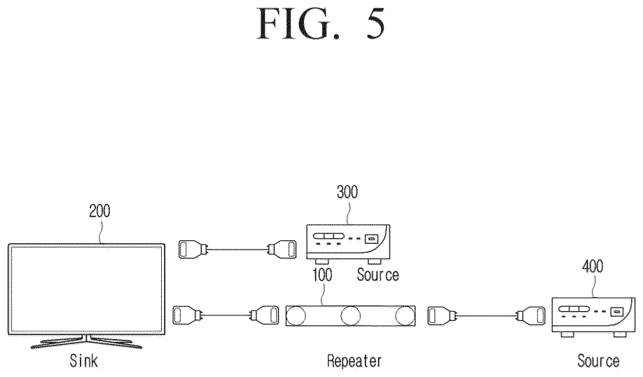

Hereinafter, operations of the first electronic apparatus 100 will be described in more detail with reference to FIG. 5 to FIG. 13. In FIG. 5 to FIG. 13, individual embodiments will be explained for the convenience of explanation. However, the individual embodiments in FIG. 5 to FIG. 13 may also be carried out in any combined states.

FIG. 5 is a diagram illustrating the first electronic apparatus 100 and the second electronic apparatus 200 according to one or more embodiments.

As illustrated in FIG. 5, the electronic system 1000 may include a first electronic apparatus (a repeater) 100, a second electronic apparatus (a sink) 200, and a plurality of source devices (sources) 300, 400. A source device may be the originator of data, while a repeater may be a network device that receives signals and retransmits them to extend a transmission range of the data. A sink device may be a target destination or end-point that ultimately receives and may process the data. In the HDMI communication method, a TV is a sink, and a sink and a source were displayed according to the HDMI communication method in FIG. 5, but a sound may be transmitted from the second electronic apparatus 200 or the plurality of source devices 300, 400 to the first electronic apparatus 100. However, the disclosure is not limited thereto, and the electronic system 1000 may be implemented while some components have been excluded or integrated.

The first electronic apparatus 100 may be connected with the second electronic apparatus 200 through an interface for performing communication by the HDMI communication method. The data communication method for transmitting a sound may include at least one of the ARC communication method or the eARC communication method.

In the first electronic apparatus 100, information on whether the second electronic apparatus 200 supports the eARC communication method and information on whether the second electronic apparatus 200 is set to use the eARC communication method even if it supports the eARC communication method are not stored, and in this case, a latency may be generated.

For preventing the latency, the first electronic apparatus 100 may receive the setting information on the data transmission method of the second electronic apparatus 200 from the server, and perform communication with the second electronic apparatus 200 without a latency based on the setting information.

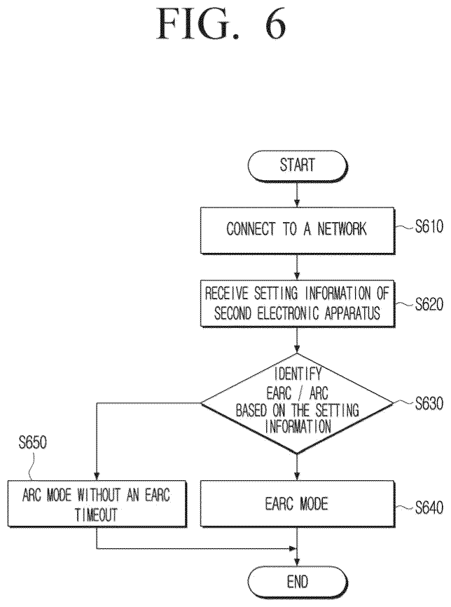

FIG. 6 is a flowchart illustrating a method of forming a communication channel by receiving setting information in advance according to one or more embodiments.

First, if the first electronic apparatus 100 is connected to the network in operation S610, the processor 140 may request setting information on a data transmission method of the second electronic apparatus 200 from a server, and receive the setting information from the server in operation S620.

The processor 140 may identify setting information of the second electronic apparatus 200 regarding the ARC communication method or the eARC communication method based on the setting information in operation S630, and perform communication with the second electronic apparatus 200 in the eARC mode in operation S640, or perform communication with the second electronic apparatus 200 in the ARC mode without an eARC TimeOut in operation S650.

For example, if it is identified that the second electronic apparatus 200 does not support the eARC communication method or is set to not use the eARC communication method based on the setting information, the processor 140 may perform communication with the second electronic apparatus 200 in the ARC mode without an eARC TimeOut in operation S650.

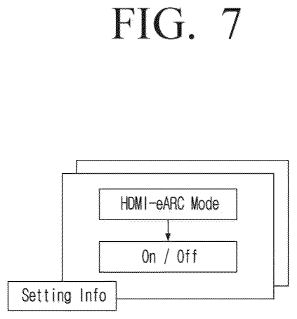

FIG. 7 is a diagram illustrating setting information according to one or more embodiments.

As illustrated in FIG. 7, the setting information may include setting information of the second electronic apparatus 200 regarding the eARC communication method. The setting information may include configuration parameters of the second electronic apparatus 200, which operates as a sink device. For example, the setting information may include information regarding On or Off of the eARC communication method. If On information of the eARC communication method is received, the processor 140 may perform communication with the second electronic apparatus 200 in the eARC mode, and if Off information of the eARC communication method is received, the processor 140 may perform communication with the second electronic apparatus 200 in the ARC mode.

Alternatively, the setting information may include compatibility information of the second electronic apparatus 200 regarding the eARC communication method. The setting information may include information wherein the communication method supported by the second electronic apparatus 200 is the ARC communication method. If information that the communication method supported by the second electronic apparatus 200 is the ARC communication method is received, the processor 140 may perform communication with the second electronic apparatus 200 in the ARC mode, and if information that the communication methods supported by the second electronic apparatus 200 are the ARC communication method and the eARC communication method is received, the processor 140 may perform communication with the second electronic apparatus 200 in the eARC mode.

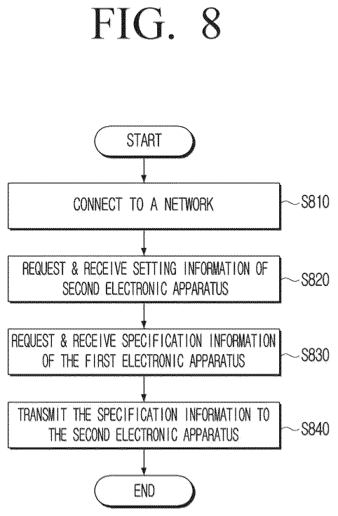

FIG. 8 is a flowchart illustrating a method of transmitting specification information according to an embodiment of the disclosure.

If the first electronic apparatus 100 is connected to the network in operation S810, the processor 140 may request setting information on a data transmission method of the second electronic apparatus 200 from a server and receive the setting information of the second electronic apparatus 200 from the server in operation S820, and request the specification information of the first electronic apparatus 100 from the server and receive the specification information of the first electronic apparatus 100 from the server in operation S830.

However, the disclosure is not limited thereto, and the processor 140 may receive the specification information of the first electronic apparatus 100 from the server regardless of the setting information of the second electronic apparatus 200. Alternatively, the first electronic apparatus 100 may store the specification information in the manufacturing process.

The processor 140 may transmit the specification information to the second electronic apparatus 200 in operation S840.

The second electronic apparatus 200 may change an output time point of a video based on the specification information of the first electronic apparatus 100. For example, the second electronic apparatus 200 may identify how much an output time point of a sound provided by the second electronic apparatus 200 to the first electronic apparatus 100 is delayed based on the specification information of the first electronic apparatus 100, and delay an output time point of a video through the display of the second electronic apparatus 200 based on this. Through such an operation, sync of a video output from the second electronic apparatus 200 and a sound output from the first electronic apparatus 100 may be matched.

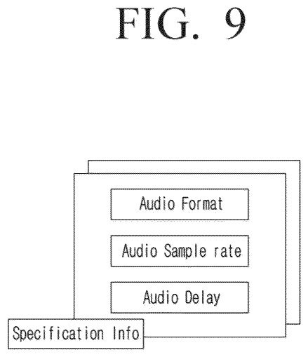

FIG. 9 to FIG. 12 are diagrams illustrating specification information according to one or more embodiments.

The specification information may include device specifications of the first electronic apparatus 100 which operates as a repeater. As illustrated in FIG. 9, the specification information may include at least one of an audio format supported by the first electronic apparatus 100, an audio sample rate, or delay information.

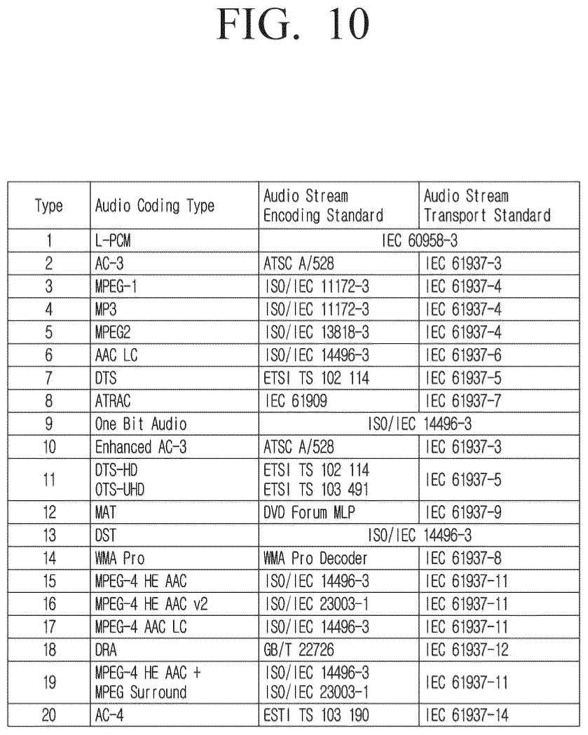

As illustrated in FIG. 10, the audio format may include at least one of an audio coding type, an audio stream encoding standard, or an audio stream transmission standard, etc.

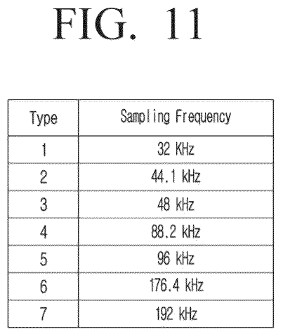

The audio sample rate may include frequency information as illustrated in FIG. 11.

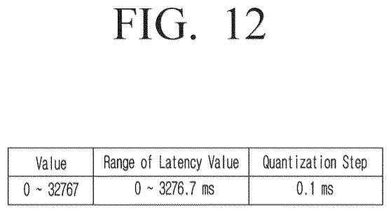

The delay information may include information on the delay time as illustrated in FIG. 12.

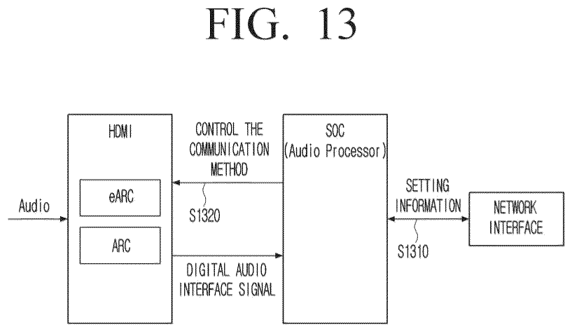

FIG. 13 is a block diagram illustrating control of a communication method according to one or more embodiments.

As illustrated in FIG. 13, the processor (SoC) 140 may receive setting information on a data transmission method of the second electronic apparatus 200 from the server through the first communication interface (a network interface) 120 in operation S1310.

The processor 140 may control the communication method based on the setting information in operation S1320. For example, the processor 140 may control an interface for performing communication by the HDMI communication method so as to operate in the ARC mode or operate in the eARC mode based on the setting information.

According to one or more embodiments, the processor 140 may receive a video and a sound from a source device, and in this case, the processor 140 may adjust the sync of the video and the sound based on the setting information, and transmit them to the second electronic apparatus 200.

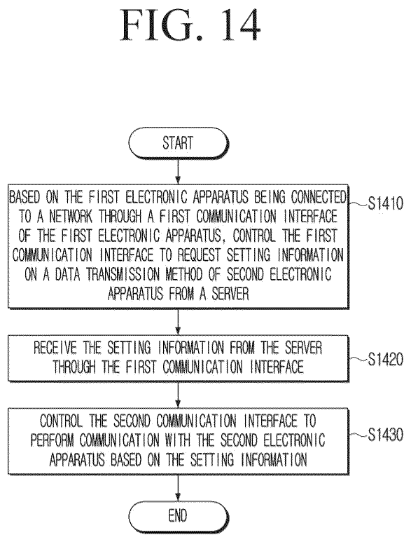

FIG. 14 is a flowchart illustrating a control method of an electronic apparatus according to one or more embodiments.

If the first electronic apparatus is connected to the network through the first communication interface of the first electronic apparatus, the first communication interface is controlled to request setting information on a data transmission method of the second electronic apparatus from the server in operation S1410. Then, the setting information is received from the server through the first communication interface in operation S1420. Then, the second communication interface of the first electronic apparatus is controlled to perform communication with the second electronic apparatus based on the setting information in operation S1430.

Also, in operation 1410 of controlling the first communication interface, while the first electronic apparatus is connected to the second electronic apparatus through the second communication interface, if the first electronic apparatus is connected to the network through the first communication interface, the first communication interface may be controlled to request the setting information from the server, and in operation 1430 of controlling the second communication interface, if the setting information is received, the second communication interface may be controlled to perform communication with the second electronic apparatus based on a data transmission method corresponding to the setting information.

In operation 1430 of controlling the second communication interface, a content may be changed based on the data transmission method corresponding to the setting information, and the second communication interface may be controlled to transmit the changed content to the second electronic apparatus.

Also, the control method may further include operations of, while the first electronic apparatus is connected to the network through the first communication interface, based on the first electronic apparatus being connected to the second electronic apparatus through the second communication interface, controlling the first communication interface to re-request the setting information from the server, re-receiving the setting information from the server through the first communication interface, and based on re-receiving the setting information, controlling the second communication interface to perform communication with the second electronic apparatus on the basis of a data transmission method corresponding to the re-received setting information.

In addition, the control method may further include operations of, based on receiving the setting information, storing the setting information, and based on the setting information being updated in the second electronic apparatus, and the updated setting information being received from the server through the first communication interface, controlling the second communication interface to perform communication with the second electronic apparatus based on the updated setting information.

Further, the data transmission method may include at least one of an ARC communication method or an eARC communication method.

Also, the setting information may include at least one of compatibility information of the second electronic apparatus for the eARC communication method or setting information of the second electronic apparatus for the eARC communication method.

In addition, the control method may further include operations of, based on the setting information not being received, controlling the second communication interface to perform communication with the second electronic apparatus based on the eARC communication method, and based on communication with the second electronic apparatus not being performed during a predetermined time, controlling the second communication interface to perform communication with the second electronic apparatus based on the ARC communication method.

Further, the second communication interface may include an interface for performing communication by an HDMI communication method.

Also, the control method may further include operations of controlling the first communication interface to request specification information of the first electronic apparatus to the server, receiving the specification information from the server through the first communication interface, and controlling the second communication interface to transmit the specification information to the second electronic apparatus.

In addition, the specification information may include at least one of an audio format supported by the first electronic apparatus, an audio sample rate, or delay information.

According to the aforementioned various embodiments of the disclosure, an electronic apparatus may receive setting information on a data transmission method of another electronic apparatus from a server, and form a communication channel with the second electronic apparatus without a timeout.

The aforementioned various embodiments may be implemented as software including instructions stored in machine-readable storage media, which may be read by machines (e.g., computers). The machines refer to apparatuses that execute/receive instructions stored in a storage medium, and may operate according to the executed/received instructions, and the apparatuses may include the first electronic apparatus according to the aforementioned embodiments (e.g., an electronic apparatus A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. The term ‘non-transitory’ may indicate that a storage medium does not include signals, and is tangible, but does not distinguish whether data is stored in the storage medium semi-permanently or temporarily.

In addition, according to one or more embodiments, the method according to the aforementioned various embodiments may be provided while being included in a computer program product. A computer program product refers to a product, and it may be traded between a seller and a buyer. A computer program product may be distributed in the form of a storage medium that is readable by machines (e.g., compact disc read only memory (CD-ROM)), or distributed on-line through an application store (e.g., Play Store™). In the case of on-line distribution, at least a portion of a computer program product may be stored in a storage medium such as the server of the manufacturer, the server of the application store, and the memory of the relay server at least temporarily, or may be generated temporarily.

The aforementioned various embodiments may be implemented in a recording medium that may be read by a computer or an apparatus similar to a computer, by using software, hardware, or a combination thereof. In some cases, the embodiments described in this specification may be implemented as a processor itself. According to implementation by software, the embodiments such as processes and functions described in this specification may be implemented as separate software modules. Each of the software modules may perform one or more functions and operations described in this specification.

Computer instructions for performing processing operations of an apparatus according to the aforementioned various embodiments may be stored in a non-transitory computer-readable medium. Computer instructions stored in such a non-transitory computer-readable medium make the processing operations at an apparatus according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory. As specific examples of a non-transitory computer-readable medium, there may be a CD, a digital video disc (DVD), a hard disc, a blue-ray disc, a USB, a memory card, ROM and the like.

Also, each of the components according to the aforementioned various embodiments (e.g., a module or a program) may consist of a singular object or a plurality of objects, and among the aforementioned corresponding sub components, some sub components may be omitted, or other sub components may be further included in the various embodiments. Alternatively or additionally, some components (e.g., a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A first electronic apparatus comprising:
memory storing instructions;
a first communication interface;
a second communication interface; and
at least one processor,
wherein the instructions, when executed by the at least one processor individually or collectively, cause the first electronic apparatus to:
based on the first electronic apparatus being connected to a network through the first communication interface, control the first communication interface to request, from a server, setting information on a first data transmission method of a second electronic apparatus,
receive the setting information from the server through the first communication interface, and
control the second communication interface to perform communication with the second electronic apparatus based on the setting information.

2. The first electronic apparatus of claim 1, wherein the instructions, when executed by the at least one processor individually or collectively, further cause the first electronic apparatus to, while the first electronic apparatus is connected to the second electronic apparatus through the second communication interface:
based on the first electronic apparatus being connected to the network through the first communication interface, control the first communication interface to request, from the server, the setting information,
receive the setting information from the server through the first communication interface, and
based on receiving the setting information, control the second communication interface to perform communication with the second electronic apparatus based on a second data transmission method corresponding to the setting information.

3. The first electronic apparatus of claim 2, wherein the instructions, when executed by the at least one processor individually or collectively, further cause the first electronic apparatus to:
change a content based on the second data transmission method corresponding to the setting information, and
control the second communication interface to transmit the changed content to the second electronic apparatus.

4. The first electronic apparatus of claim 1, wherein the instructions, when executed by the at least one processor individually or collectively, further cause the first electronic apparatus to, while the first electronic apparatus is connected to the network through the first communication interface:
based on the first electronic apparatus being connected to the second electronic apparatus through the second communication interface, control the first communication interface to re-request, from the server, the setting information,
re-receive the setting information from the server through the first communication interface, and
based on re-receiving the setting information, control the second communication interface to perform communication with the second electronic apparatus based on a third data transmission method corresponding to the re-received setting information.

5. The first electronic apparatus of claim 1, wherein the instructions, when executed by the at least one processor individually or collectively, further cause the first electronic apparatus to:
based on receiving the setting information, store the setting information in the memory, and
based on the setting information being updated in the second electronic apparatus, and the updated setting information being received from the server through the first communication interface, control the second communication interface to perform communication with the second electronic apparatus based on the updated setting information.

6. The first electronic apparatus of claim 1, wherein the first data transmission method comprises at least one of an audio return channel (ARC) communication method or an enhanced audio return channel (eARC) communication method.

7. The first electronic apparatus of claim 6, wherein the setting information comprises at least one of compatibility information of the second electronic apparatus for the eARC communication method or setting information of the second electronic apparatus for the eARC communication method.

8. The first electronic apparatus of claim 6, wherein the instructions, when executed by the at least one processor individually or collectively, further cause the first electronic apparatus to:
based on the setting information not being received, control the second communication interface to perform communication with the second electronic apparatus on based on the eARC communication method, and
based on communication with the second electronic apparatus not being performed during a predetermined time, control the second communication interface to perform communication with the second electronic apparatus based on the ARC communication method.

9. The first electronic apparatus of claim 1, wherein the second communication interface comprises an interface for performing communication by a high-definition multimedia interface (HDMI) communication method.

10. The first electronic apparatus of claim 1, wherein the instructions, when executed by the at least one processor individually or collectively, further cause the first electronic apparatus to:
control the first communication interface to request, from the server, specification information of the first electronic apparatus,
receive the specification information from the server through the first communication interface, and
control the second communication interface to transmit the specification information to the second electronic apparatus.

11. The first electronic apparatus of claim 10, wherein the specification information comprises at least one of an audio format supported by the first electronic apparatus, an audio sample rate, or delay information.

12. A control method of a first electronic apparatus, the control method comprising:
based on the first electronic apparatus being connected to a network through a first communication interface of the first electronic apparatus, controlling the first communication interface to request, from a server, setting information on a first data transmission method of second electronic apparatus;
receiving the setting information from the server through the first communication interface; and
controlling a second communication interface of the first electronic apparatus to perform communication with the second electronic apparatus based on the setting information.

13. The control method of claim 12, wherein the controlling the first communication interface comprises, while the first electronic apparatus is connected to the second electronic apparatus through the second communication interface:
based on the first electronic apparatus being connected to the network through the first communication interface, controlling the first communication interface to request the setting information from the server, and
wherein the controlling the second communication interface comprises, based on receiving the setting information, controlling the second communication interface to perform communication with the second electronic apparatus based on a second data transmission method corresponding to the setting information.

14. The control method of claim 13, wherein the controlling the second communication interface further comprises:
changing a content based on the second data transmission method corresponding to the setting information, and
controlling the second communication interface to transmit the changed content to the second electronic apparatus.

15. The control method of claim 12, further comprising, while the first electronic apparatus is connected to the network through the first communication interface:
based on the first electronic apparatus being connected to the second electronic apparatus through the second communication interface, controlling the first communication interface to re-request the setting information to the server;
re-receiving the setting information from the server through the first communication interface; and
based on re-receiving the setting information, controlling the second communication interface to perform communication with the second electronic apparatus based on a third data transmission method corresponding to the re-received setting information.

16. The control method of claim 12, further comprising:
based on receiving the setting information, storing the setting information, and
based on the setting information being updated in the second electronic apparatus, and the updated setting information being received from the server through the first communication interface, controlling the second communication interface to perform communication with the second electronic apparatus based on the updated setting information.

17. The control method of claim 12, wherein the first data transmission method comprises at least one of an audio return channel (ARC) communication method or an enhanced audio return channel (eARC) communication method.

18. The control method of claim 17, wherein the setting information comprises at least one of compatibility information of the second electronic apparatus for the eARC communication method or setting information of the second electronic apparatus for the eARC communication method.

19. The control method of claim 17, further comprising:
based on the setting information not being received, control the second communication interface to perform communication with the second electronic apparatus based on the eARC communication method, and
based on communication with the second electronic apparatus not being performed during a predetermined time, control the second communication interface to perform communication with the second electronic apparatus based on the ARC communication method.

20. A non-transitory, computer-readable, storage medium storing instructions that, when executed by at least one processor, cause a first electronic apparatus to:
based on the first electronic apparatus being connected to a network through a first communication interface of the first electronic apparatus, control the first communication interface to request, from a server, setting information on a first data transmission method of second electronic apparatus;
receive the setting information from the server through the first communication interface; and
control a second communication interface of the first electronic apparatus to perform communication with the second electronic apparatus based on the setting information.
